(19) United States
(12) Patent Application Publication
(10) Pub. No.: US 2007/0154373 A1
(43) Pub. Date: Jul. 5, 2007

(54) Methods for regenerating oxidants used for removing pollutants from a gas stream

(75) Inventors: Dennis W. Johnson, Simpsonville, SC (US); Mark S. Ehrnschwender, Terrace Park, OH (US)

Correspondence Address: WOOD, HERRON & EVANS, LLP, 2700 CAREW TOWER, 441 VINE STREET, CINCINNATI, OH, 45202, US

(73) Assignee: EnviroSolv Energy LLC, Terrace Park, OH (US)

(21) Appl. No.: 11/326,258

(22) Filed: Jan. 5, 2006

(51) Int. Cl. B01D 53/46

(52) U.S. Cl. 423/210

(57) ABSTRACT

Methods for regenerating oxidant solutions used for removing pollutants, such as sulfur oxides, nitrogen oxides, mercury compounds, carbon monoxide, and elemental mercury (Hg), from gas streams.

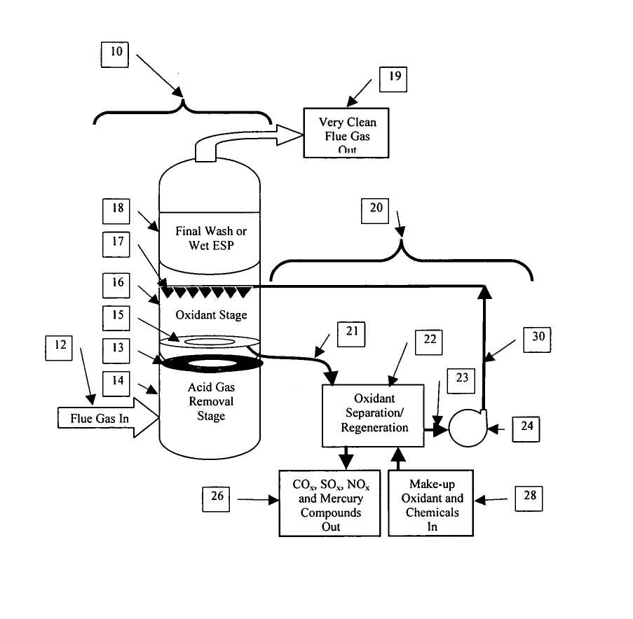

### FIELD OF THE INVENTION

The present invention relates to methods for regenerating oxidants used for removing pollutants, such as sulfur oxides, nitrogen oxides, carbon monoxide, mercury compounds, and elemental mercury (Hg), from gas streams.

### BACKGROUND OF THE INVENTION

Acid gases such as HCl, HF, SO₂, SO₃, H₂S, NO₂, and other reactive gas compounds may be removed in the initial stage(s) of a staged scrubber where these acid gas species are at least partially removed using one or more sorbents that are either injected wet or dry into the gas stream and/or introduced into a wet scrubber and/or used in a polishing step downstream the wet scrubber. The sorbent(s) are alkali compound selected from known acid gas reagents including alkali compounds of calcium, potassium, ammonium, magnesium, sodium, and other known sorbents or reagents, whether used alone or in combination with other reagents, sorbents, performance enhancing additives, or physical property modifying additives. Regardless of whether 1, 2 or 3 or more upstream stages are used, the final reagent will generally be selected from the more soluble and hence more reactive alkali sorbents such as those that are sodium, potassium, and ammonium based or those used in combination with other sorbents or additives to achieve the high removal. The acid gas removal combination of 1, 2 or 3 or more stages results in a partially cleaned gas stream that has most of the acid gases present, but still contains a portion of the acid gases as well as mercury or mercury compounds, CO, and NOₓ primarily in the form of NO, which are not effectively removed by compounds typically used for acid gas scrubbing.

An oxidation stage may be employed to remove the final portion of the acid gases (sulfur oxides, NO₂, etc.), as well as mercury or mercury compounds, CO, and NOₓ primarily in the form of NO. This stage uses chemical oxidants to effectively remove pollutants from the gas stream. However, these oxidants may be expensive.

The final stage of the conventional systems, when required, is a final wash or a wet electrostatic precipitator chosen to remove and undesirable solid, liquid, and/or aerosol components in the gas to produce a cleaned gas.

### SUMMARY OF THE INVENTION

The present invention is a regeneration step that is used to produce oxidants from the spent reaction products of the SOₓ, NOₓ, CO, Hg, and mercury compounds and the oxidant. The regeneration step reduces the overall cost of the process, reduces the amount of waste produced, reduces the transportation and handling requirements of strong oxidizers, and allows production of valuable products. The regeneration method will consists of step to separate the reaction products from the bulk stream followed by equipment including electrochemical cells and other methods to regenerate the oxidants The methods of the invention are particularly beneficial for regenerating permanganate, chlorate, and peroxide based oxidants used in removal of mercury-containing substances, sulfur oxides, carbon monoxide, and nitrogen oxides from gas streams, such as gas streams generated by the combustion of fossil fuels.

These and other advantages of the present invention shall become more apparent from the accompanying drawings and description thereof.

### BRIEF DESCRIPTION OF THE DRAWING

The accompanying drawing, which is incorporated in and constitutes a part of this specification, illustrates embodiments of the invention and, together with a general description of the invention given above, and the detailed description given below, serves to explain the principles of the invention.

The Figure is a schematic representation of a scrubber arrangement with an oxidant regeneration system in accordance with the principles of the present invention.

### DETAILED DESCRIPTION

With reference to the Figure, a scrubber 10 constitutes a scrubber/pollution control technology that employs one or more stages. The principles of the invention apply to all scrubbing systems for gases that contain any of or any combination of the following species: sulfur oxides (SOₓ), nitrogen oxides (NOₓ), carbon monoxide (CO), and mercury (Hg)-containing substances. The gases may, in addition, have other acid gases present such as HCl, HF, and H₂S. The principles of the invention apply to both new installations and modifications of existing units. Scrubber arrangement 10 is used to remove acid gases including SOₓ and NOₓ from a gas stream when present in quantities that make it more economical or technically preferably to remove the acid gases using alkalis rather than oxidants. In cases where said acid gases are removed by alkali scrubbing, this occurs in an acid gas removal component 14 of the scrubber arrangement 10 that scrubs the acid gas components from gas stream 12 producing a partially clean gas stream which has some or most of the acid gases removed. The acid gas removal component 14 can be a single stage or can be multiple stages which would include any combination of wet or dry injection, wet scrubbing such as with a calcium based sorbent that only removes some of the acid gases, typically 98% or less, and a polishing step or steps which would generally employ a soluble sorbent to result in removal of almost all of the acid gases. Thus, the acid gas removal component 14 contacts the gas stream 12 with a scrubbing fluid that is typically composed of water and a basic chemical including, but not limited to, lime, calcium carbonate or limestone, soda ash or other sodium based alkalis, magnesium based alkalis, buffered calcium, and other calcium based alkalis, amines, and other ammonium based compounds, or mixtures of these materials. The scrubbing fluid may also include any of a number of additives intended to enhance or promote removal, control chemistry, reduce chemical scale, or otherwise modify the chemistry of the fluid.

The acid gas removal stage 14 may be a single stage that uses highly reactive soluble sorbents and the mass transfer devices, such as sprays, packing, trays, and other appropriate methods. However, especially when acid gases are present in small quantities or their prior removal is not required by design, economics, or by choice, acid gas removal stage 14 is omitted from scrubber arrangement 10.

The gas in gas stream 12, which has been depleted of acid gases and, advantageously, is essentially acid gas free, then proceeds to an oxidant stage 16, which is separated from acid gas removal stage 14 by a mist eliminator system 13 and separator tray 15, such as a bubble cap tray. Oxidant stage 16 utilizes appropriate mass transfer methods, such as a spray, packing, tray, or liquid distribution device 17, to effectively remove remaining SOₓ, CO, NOₓ and/or Hg and produce a cleaner gas stream 12. This clean gas stream then proceeds to an optional final stage 18. The gas stream leaving the oxidant stage 16 may contain some byproducts, such as chlorine gas and the like, that can be washed with water and/or an alkali solution to produce a cleaned gas stream 19. The gas stream leaving the oxidant stage 16 may contain solid particles, aerosols, liquids, or other compounds that are removed effectively by the final stage 18, which in this instance is a wet electrostatic precipitator with single or multiple stages, to produce the cleaned gas stream 19. For gases such as flue gases produced from the combustion of fossil fuels such as coal, coke, oil, bitumen, and the like, the cleaned gas stream 19 would consist primarily of nitrogen, oxygen, water vapor, carbon dioxide, and other trace inert gases found in air such as argon, but is essentially depleted of pollutant gases.

The oxidant stage 16 removes at least a portion of the NOₓ, which will primarily be in the form of NO, NO₂, or other dimers, SOₓ, CO, and mercury, either in an elemental form or oxidized form from the gas stream. Advantageously, the oxidant stage 16 removes a significant portion or, most preferably, substantially all of the remaining SOₓ, CO, Hg and NOₓ from the gas stream. The oxidant stage 16 may use a separate vessel to hold the reagent, in this case an oxidant stream, separate from the lower stages so as to not interfere with the operation of the acid gas removal stage 14. The oxidant stage 16 may be an integral reaction zone that recirculates an aqueous solution of oxidant and reaction products to effectively and simultaneously remove all of the SOₓ, CO, NOₓ and a significant fraction of the mercury.

The reagent oxidant in the oxidant stage 16 is selected contingent upon the desired level of removal of SOₓ, CO, NOₓ and/or Hg containing-substances. Candidate oxidants that are useful for capture of NOₓ and/or Hg or Hg compounds include, but are not limited to, the following substances:
1) Hydrogen Peroxide
2) Hydrogen Peroxide/Nitric Acid Solution (H₂O₂/HNO₃)
3) Hydrogen Peroxide/Nitric Acid/Hydrochloric Acid Solution (H₂O₂/HNO₃/HCl)
4) Sodium Chlorate Solution (NaClO₃)
5) Sodium Chlorite Solution (NaClO₂)
6) Sodium Hypochlorite Solution (NaClO)
7) Sodium Perchlorite Solution (NaClO₄)
8) Chloric Acid Solution (HClO₃)
9) Oxone Solution (2KHSO₅—KHSO₄—K₂SO₄ Triple Salt)
10) Potassium Chlorate Solution (KClO₃)
11) Potassium Chlorite Solution (KClO₂)
12) Potassium Hypochlorite Solution (KClO)
13) Potassium Perchlorite Solution (KClO₄)
14) Potassium Permanganate (KMnO₄)
15) Potassium Permanganate/Sodium Hydroxide Solution

Other oxidants, or combinations of oxidants, may be used in the oxidant stage 16. Further, sodium carbonate and sodium bicarbonate, or other alkalis, may be substituted for the sodium hydroxide solutions used for pH adjustment and to provide the ions for complete reactions. Oxidants may be selected to remove only SOₓ, CO, NOₓ, to exclusively remove elemental Hg and mercury compounds, or to simultaneously remove SOₓ, CO, NOₓ, elemental Hg, and mercury compounds. Metal ions that promote or catalyze oxidation, including but not limited to iron, cobalt, gold, silver, platinum, and manganese, may be added to the oxidant used in the oxidant stage 16.

These oxidants may be expensive, require special handling both on site and during transportation, and the reaction products can be hazardous requiring special treatment or disposal methods. In accordance with the principles of the present invention, an oxidant regeneration system 20 is used to convert the spent oxidant solution 21 to regenerated oxidant solution 23 for re-use in the oxidant stage 16. A conduit directs the spent oxidant solution 21, which contains mercury, sulfates, carbonates, and/or nitrogenous reaction products, to the oxidant regeneration device 22. In the oxidant regeneration device 22, at least a portion of the reaction products are separated from the spent oxidant solution 21 and exit the oxidant regeneration system 20, as indicated, by a product or waste stream 26. Typically, the reaction products are separated during the conversion of the spent oxidant solution 21 to regenerated oxidant solution 23. However, the invention contemplates that at least a portion of the reaction products may be combined with the regenerated oxidant solution 23 after generation and subsequently separated from the regenerated oxidant solution 23 to form waste stream 26 before the regenerated oxidant solution 23 is directed back to the oxidant stage 16 of scrubber 10. The invention also contemplates that at least a portion of the reaction products may be separated from the spent oxidant solution 21 to form waste stream 26 before the regenerated oxidant solution 23 is formed.

The compounds of the reaction products in waste stream 26 may be converted to usable products. Sulfuric acid, sulfates, carbonic acid, carbonates, nitric acid, nitrates, or other such compounds and may be separated from the spent oxidant solution using methods including chemical reaction, precipitation, crystallization, filtering, purging, and other appropriate methods understood by a person having ordinary skill in the art of compound separation. For example, nitrogenous reaction products may be converted to ammonium nitrate, a high value fertilizer product, by reaction with ammonia, if the nitrogeneous reaction is nitric acid, or by reaction with ammonia and carbon dioxide or ammonium bicarbonate for a sodium nitrate based nitrogenous reaction product. Some compounds such as mercury may be separated from the oxidant solution using mercury specific ion exchange resins or activated carbon. The mercury recovered from waste stream 26 may be sold for recovery as a mercury product or disposed by appropriate methods.

Make-up oxidant and other chemicals may be introduced to the oxidant regeneration device 22 from a supplemental source 28 of the oxidant regeneration system 20 and combined with the regenerated oxidant solution. Of course, mercury separation in the oxidant regeneration device 22 is optional if the gas stream 12 treated by oxidant stage 16 does not contain mercury-containing substances, or if the oxidant used in oxidant stage 16 does not remove mercury-containing substances from gas stream 12.

At least a portion of regenerated oxidant solution 23 and/or recycled reaction products are directed through the fluid path 30 to the oxidant stage 16 with the assistance of pump 24. This returns or recycles the regenerated oxidant solution 23 and/or recycled reaction products, along with any make-up oxidant or other chemicals from the supplemental source 28, to the oxidant stage 16 for re-use in treating gas stream 12.

The regeneration of oxidants in the oxidant solution directed to oxidant regeneration device 22 of oxidant regeneration system 20 may be accomplished by chemical reaction, other chemical methods such as the introduction of ozone, chloride dioxide, or other such oxidizers or other known methods. For example, electrochemical methods may be used to produce permanganates, chlorates, and peroxides that would subsequently be used to regenerate the oxidant solution. The electrochemical methods, which would treat all, or a portion, of the spent oxidant solution 21, typically employ membranes in an electrochemical cell to facilitate the separation of the ionized reaction products constituting waste stream 26. Electrical energy is imposed upon the fluid in the electrochemical cell to promote the separation of the ionized reaction products, such as sulfates and nitrates, from the spent oxidant solution and the ultimate production of regenerated oxidant solution 23 at least partially depleted of the reaction products. Make-up chemicals 28 may be added as required to facilitate the separation in the electrochemical cell, to account for oxidant lost from the oxidant solution or otherwise unrecoverable in the regeneration process, and to provide required oxygen for oxidation reactions with the pollutant substance(s) in the gas stream 12.

As a more specific example, potassium permanganate (KMnO₄) may be a component of the oxidant solution that is used for removing nitric oxide. In the oxidant stage 16, potassium permanganate reacts with nitric oxide, NO, in gas stream 12 to form spent oxidant solution 21 containing potassium nitrate and manganese oxide. In the regeneration system, the nitrate is separated from the spent oxidant solution 21 and the potassium permanganate is re-formed or regenerated for reuse in the regenerated oxidant solution 23. Make-up chemicals in the form of potassium compounds, such as potassium chloride, and manganese oxide, may be added to the regenerated oxidant solution 23 or to the oxidant regeneration system 20 as required. The nitrate reaction product may then be reacted with ammonia to form an ammonium nitrate fertilizer.

While the present invention has been illustrated by a description of various preferred embodiments and while these embodiments have been described in considerable detail in order to describe the best mode of practicing the invention, it is not the intention of applicants to restrict or in any way limit the scope of the appended claims to such detail. Additional advantages and modifications within the spirit and scope of the invention will readily appear to those skilled in the art. The invention itself should only be defined by the appended claims, wherein we claim:

1. A method of scrubbing a gas stream containing a pollutant substance, comprising:
contacting the gas stream with an oxidant solution effective to remove at least a portion of the pollutant substance as a reaction product combined with spent oxidant solution;
converting the spent oxidant solution into a regenerated oxidant solution that is at least partially depleted of the reaction product; and
using at least a portion of the regenerated oxidant solution as the oxidant solution contacted with the gas stream.

2. The method of claim 1 further comprising;
combining at least one of fresh oxidant, make-up oxidant, or make-up chemicals with the regenerated oxidant solution to formulate the oxidant solution before contacting the gas stream with the oxidant solution.

3. The method of claim 1 further comprising:
separating at least a portion of the reaction product from the spent oxidant solution or the regenerated oxidant solution.

4. The method of claim 3 wherein separating at least a portion of the reaction product from the spent oxidant solution further comprises:
using chemical reaction, precipitation, crystallization, filtering, purging, chemical methods, or electrochemical methods.

5. The method of claim 1 wherein the pollutant substance is NOₓ and the reaction product is a nitrogeneous reaction product, and further comprising:
separating the nitrogenous reaction product from the spent oxidant solution or the regenerated oxidant solution; and
converting the separated nitrogenous reaction product to ammonium nitrate.

6. The method of claim 1 wherein the pollutant substance is mercury or a mercury compound and the reaction product is a mercury-containing substance, and further comprising:
removing the mercury-containing substance from the spent oxidant solution or the regenerated oxidant solution using mercury specific ion exchange resins or activated carbon.

7. The method of claim 1 wherein the pollutant substance further comprises an acid gas substance selected from the group consisting of HCl, HF, SO₂, SO₃, H₂S, CO, and mixtures thereof, and the reaction product of the oxidant solution and the acid gas substance is an acid gas reaction product, and further comprising:
removing at least a portion of the acid gas reaction product from the spent oxidant solution or the regenerated oxidant.

8. The method of claim 1 wherein the pollutant substance is partially removed from the gas stream with a sorbent before contacting the gas stream with the oxidant solution.

9. The method of claim 8 wherein the sorbent partially removes the pollutant substance from the gas stream in a dry injection stage.

10. The method of claim 8 wherein the sorbent partially removes the pollutant substance from the gas stream in a wet injection stage.

11. The method of claim 8 wherein the sorbent partially removes the pollutant substance from the gas stream in a wet scrubber.

12. The method of claim 8 wherein the sorbent partially removes the pollutant substance from the gas stream in a polishing wet scrubber.

13. The method of claim 12 wherein the sorbent is a soluble alkali sorbent.

14. The method of claim 8 further comprising:
treating the gas stream with at least one of a mist eliminator or a separator tray after the pollutant substance portion is partially removed from the gas stream and before contacting the gas stream with the oxidant solution.

15. The method of claim 1 wherein the oxidant solution is an aqueous solution formed using a chemical compound selected from the group consisting of hydrogen peroxide, sodium chlorate, sodium chlorite, sodium hypochlorite, sodium perchlorite, chloric acid/sodium chlorate, chloric acid, potassium chlorate, potassium chlorite, potassium hypochlorite, potassium perchlorite, potassium permanganate, and combinations thereof.

16. The method of claim 15 wherein the oxidant solution further includes an acid selected from the group consisting of nitric acid, hydrochloric acid, sulfuric acid, and combinations thereof or an alkali selected from the group consisting of caustic soda, sodium carbonate, sodium bicarbonate, and combinations thereof.

17. The method of claim 15 wherein the oxidant solution further includes metal ions.

18. The method of claim 1 wherein converting the spent oxidant solution into the regenerated oxidant solution further comprises:
using chemical reaction, chemical methods, or electrochemical methods to accomplish the conversion.
